(19) United States
(12) Patent Application Publication
(10) Pub. No.: US 2010/0304864 A1
(43) Pub. Date: Dec. 2, 2010

(54) FEEDBACK APPARATUS FOR A GAME

(75) Inventors: Mark Thomas Johnson, Eindhoven (NL); Olaf Martinus Johannes Van T Erve, Arlington, VA (US); Dirk Brokken, Eindhoven (NL); Floris Maria Hermansz Crompvoets, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/679,043

(22) PCT Filed: Sep. 17, 2008
(86) PCT No.: PCT/IB08/53775

§ 371 Date: Mar. 29, 2010

(30) Foreign Application Priority Data
Sep. 20, 2007 (EP) 07116841.3

(51) Int. Cl. A63F 13/06; A63F 9/24

(52) U.S. Cl. 463/36; 463/43

(57) ABSTRACT

There is provided a feedback apparatus for a game, the feedback apparatus comprising at least one electrode for attachment to a user of the feedback apparatus; and a control unit for measuring at least one physiological characteristic of the user via the at least one electrode; for determining whether the at least one electrode has been attached correctly to the user for a predefined electro-stimulation signal level based on the measured at least one physiological characteristic; and for providing an electro-stimulation signal at the predefined level to the user via the at least one electrode in response to an output from the game if it is determined that the at least one electrode has been attached correctly to the user.

### TECHNICAL FIELD OF THE INVENTION

The invention relates to a feedback apparatus for a game, and in particular to a feedback apparatus for a game that provides an electro-stimulation to a user.

### BACKGROUND TO THE INVENTION

Many electronic devices, such as computers and computer game consoles, have a means for providing physical feedback to a user relating to events in a computer game. One way in which this feedback is provided is by vibrations through a handheld controller or joystick. Another way is through “force feedback” which is the feedback of a resisting force to the movements of the controller by the user. An example of this is in steering wheel controllers in which the steering wheel resists turns or slips out of control.

To increase the realism of a computer game for a user, it has been suggested to provide feedback to the user in the form of muscle stimulation. One such system is described in US 2004/229702 to Michael Charles Cooke.

As an alternative to stimulating muscles, devices are known that stimulate nerves (which in turn stimulate muscles). One such device is a Transcutaneous Electrical Neural Stimulation (TENS) device, and is well known for use in medical applications.

However, whilst it is acceptable for suitably-trained people to operate TENS devices (or similar devices that provide some form of electrical stimulation to the body) in a laboratory or medical setting, it will be appreciated that the misuse (whether intentional or unintentional) of such a device by a user of a home computer or computer games console can be dangerous and harmful.

### SUMMARY OF THE INVENTION

Thus, it is an object of the invention to provide a feedback apparatus for a game that provides electro-stimulation and in which the risk of misuse of the device is reduced.

In accordance with a first aspect of the invention, there is provided a feedback apparatus for a game, the feedback apparatus comprising at least one electrode for attachment to a user of the feedback apparatus; and a control unit for measuring at least one physiological characteristic of the user via the at least one electrode; for determining whether the at least one electrode has been attached correctly to the user for a predefined electro-stimulation signal level based on the measured at least one physiological characteristic; and for providing an electro-stimulation signal at the predefined level to the user via the at least one electrode in response to an output from the game if it is determined that the at least one electrode has been attached correctly to the user.

According to a second aspect of the invention, there is provided a computer comprising a feedback apparatus as described above.

According to a third aspect of the invention, there is provided a computer game console comprising a feedback apparatus as described above.

According to a fourth aspect of the invention, there is provided a user interface for a computer or a computer game console, the user interface comprising a feedback apparatus as described above.

According to a fifth aspect of the invention, there is provided a method of operating a feedback apparatus for a game, the feedback apparatus having at least one electrode for applying an electro-stimulation signal to a user of the apparatus, the method comprising measuring at least one physiological characteristic of the user of the feedback apparatus using the at least one electrode attached to the user; determining whether the at least one electrode has been attached correctly to the user for a predefined electro-stimulation signal level based on the measured at least one physiological characteristic of the user; and if it is determined that the at least one electrode has been attached correctly to the user, allowing the application of an electro-stimulation signal at the predefined level to the user via the at least one electrode in response to an output from the game.

According to a sixth aspect of the invention, there is provided a computer program, comprising code for enabling a processor to perform the method as described above.

### BRIEF DESCRIPTION OF THE DRAWINGS

The invention will now be described, by way of example only, with reference to the following drawings, in which:

FIG. 1 shows a feedback apparatus in use by a user in accordance with the invention;

FIG. 2 is a block diagram of a feedback apparatus in accordance with a first embodiment of the invention;

FIG. 3 is a flow chart illustrating a method in accordance with the invention; and

FIG. 4 is a block diagram of a feedback apparatus in accordance with a second embodiment of the invention.

### DETAILED DESCRIPTION OF THE PREFERRED EMBODIMENTS

The invention will now be described with reference to a feedback apparatus that provides electro-stimulation to nerves in the body of a user (and in particular to an apparatus that includes a TENS device), but it will be appreciated that the invention can also be applied specifically for Galvanic Vestibular Stimulation, or to an apparatus that provides electro-stimulation directly to the muscles, or other functional tissues such as membranes, vocal chords, eyes or vestibular organs of the user.

In addition, although the invention will be described below as a feedback apparatus for a computer game, it will be appreciated that the invention can be applied to any type of game or entertainment application (electronic, computer, or otherwise) in which electro-stimulation can be used to provide feedback to a user.

As described above, the misuse (whether intentional or unintentional) of a feedback apparatus that includes a TENS device by a user can be dangerous and harmful. Such misuse can include placing the electrodes used to apply the electro-stimulation to the user in an inappropriate position on the body of the user, or on an inappropriate object. For example, if the electrodes are placed on the body of the user such that the applied current passes through a region of the body that includes a vital organ such as the heart, the applied current can interfere with the normal operation of the heart, which can have severe consequences.

In the following, the “correct” attachment of an electrode or set of electrodes to a user is determined from the position on the body of a user that the electrodes are attached, and to the strength of the electro-stimulation signal that is to be applied to the user via the electrodes.

For example, while an electrode or pair of electrodes may be attached “correctly” to a user when they are attached to opposite arms and the electro-stimulation signal is at a first strength, these electrodes will be attached “incorrectly” if the electro-stimulation signal is at a second strength that is significantly higher than the first strength, and the application of the signal at the second strength could be unsafe or dangerous to the user. However, the application of the electro-stimulation signal at the second strength could be safe if the electrodes are attached “correctly” to the user, i.e. if they are attached to the same arm. Electrodes can also be deemed “incorrectly” attached if one or more of the electrodes are not attached to the user.

Therefore the “correct” attachment of an electrode or electrodes to a user is a function of both the strength of the electro-stimulation signal to be applied, and the position or relative positions of the electrode or electrodes on the user. Thus, the “incorrect” attachment of an electrode or electrodes to a user indicates that the electrode or electrodes have been positioned on the user in an inappropriate place for the strength of the electro-stimulation signal to be applied.

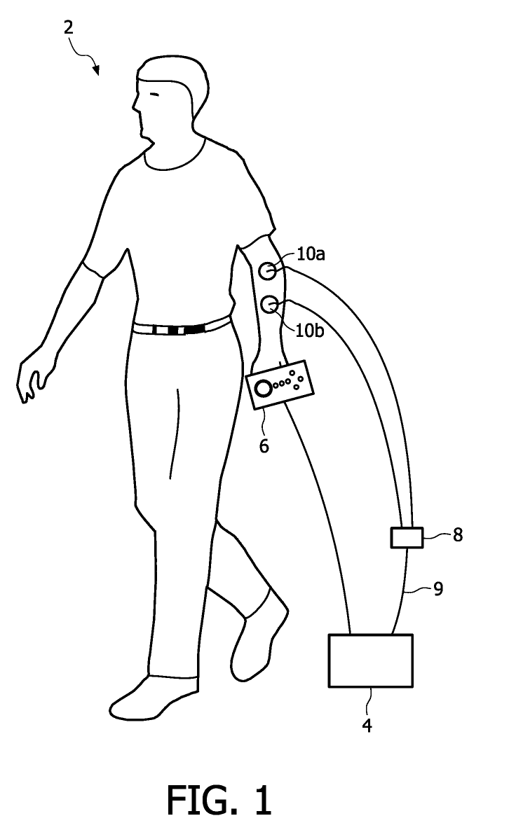

FIG. 1 shows a user 2 and a computer game console 4. The computer game console 4 has a controller 6 that comprises a plurality of buttons or controls which allows user 2 to interact with the console 4. The controller 6 may include a conventional vibration or force-feedback function as described above.

A feedback apparatus 8 is also provided that is connected to the console 4 via a cable 9. The feedback apparatus 8 may be connected to the console 4 using any type of wired connection, including USB or FireWire, or any type of wireless connection.

The feedback apparatus 8 comprises a pair of electrodes or electrode arrays 10a, 10b that are attached to one arm of the user 2. In this illustration, the electrodes 10a, 10b have been correctly placed on the user 2, as an electro-stimulation current of a given strength will pass through a short length of the same arm. However, if an electrode 10 were placed on each arm, that current would need to pass through the chest cavity, which can be dangerous. The same problem occurs if one or both of the electrodes 10 are placed on or near the chest cavity.

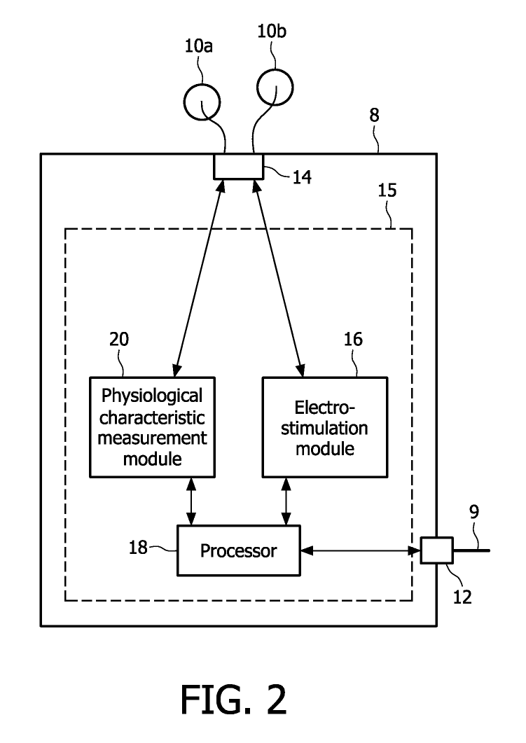

FIG. 2 shows a feedback apparatus 8 in accordance with a first embodiment of the invention. The feedback apparatus 8 comprises an input/connection port 12 which is used to connect the apparatus 8 to the console 4 via the cable 9. The apparatus 8 also comprises an electrode port 14 into which the electrodes 10a, 10b are connected.

Although two electrodes 10 are shown in this Fig., it will be appreciated that any number of electrodes 10 can be provided (for example there can be a pair of electrodes 10 for each arm, or each limb).

The feedback apparatus also comprises a control unit 15 that includes an electro-stimulation module 16 which supplies the required signals to the electrodes 10, under the control of a processor 18. The processor 18 is connected to the input/connection port 12, through which it receives outputs from the console 4 or other electronic device relating to feedback to be provided to the user.

The control unit 15 of the apparatus 8 further comprises a physiological characteristic measurement module 20 which is connected to the electrode port 14 and the processor 18. The physiological characteristic measurement module 20 measures at least one physiological characteristic of the user through one or more of the electrodes 10. Depending on the physiological characteristic being measured, the module 20 may measure the characteristic directly using the electrode(s) 10, or via a dedicated sensor (not shown) that is integrally formed with the electrode(s) 10.

The processor 18 receives the measurements of the at least one physiological characteristic and determines whether the electrodes 10 have been attached correctly to the user 2. This determination can be carried out by comparing the measurements to a predetermined threshold or a predetermined range of values (depending on the characteristic being measured).

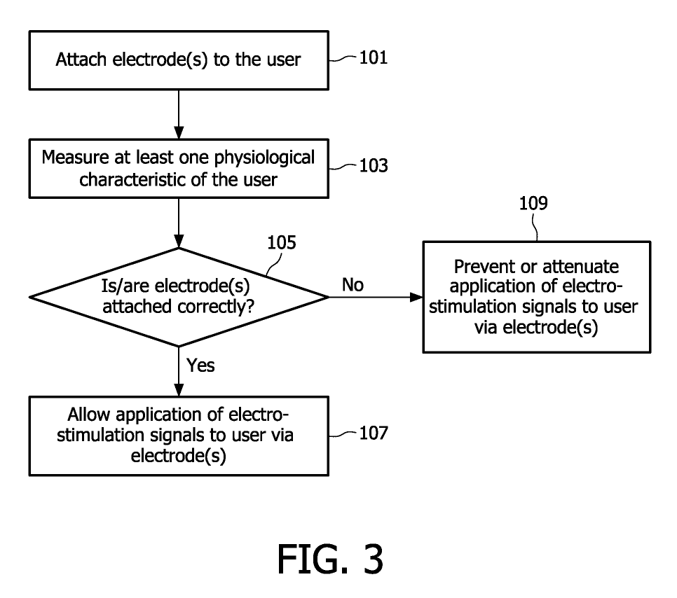

FIG. 3 illustrates a method of operating the feedback apparatus 8. In step 101, the electrode or electrodes 10 are attached to the user 2. The electrodes 10 may be directly electrically contacted to the user via a conductive medium (such as a conductive adhesive). Alternatively, the electrodes 10 could be pressed onto the user using, for example, a band or belt. In the latter case, a thin insulating layer of air may separate the electrode 10 from the user, but the electrode may still be considered as attached as it is still possible to transmit higher frequency AC electrical signals between electrode and user. At this stage, the electrodes 10 could be positioned anywhere on the user 2, so it is necessary for the apparatus 8 to determine whether it is safe to apply electro-stimulation signals via the electrode(s).

In step 103, at least one physiological characteristic of the user 2 is measured by the physiological characteristic measurement module 20 using the electrode(s) 10.

In step 105, it is determined whether the electrode(s) 10 have been correctly attached to the user 2 (for example it is determined whether they have been connected across the heart). This determination is based on the measurement of the at least one physiological characteristic in step 103. In one embodiment, this determination also takes into account the strength of the electro-stimulation signal to be applied to the user.

If it is determined that the electrode(s) 10 have been attached to the user 2 correctly, the method passes to step 107 in which the application of electro-stimulation signals via the electrode(s) 10 is permitted. These signals will be generated by the electro-stimulation module 16 in response to an appropriate output from the computer game on the console 4.

If it is determined that one or more electrodes 10 are attached to the user 2 incorrectly, the method passes to step 109 in which the application of electro-stimulation signals via the electrode(s) 10 is prevented or attenuated. Due to the relationship between the positioning of the electrodes and the electro-stimulation signal strength, the attenuation of the strength of the electro-stimulation signal can then result in the electrodes being deemed “correctly” placed, provided that the attenuated signal strength is suitable for the locations of the electrodes.

This method ensures that if the electrodes are attached incorrectly to the user 2, the application of electro-stimulation signals will be stopped, or their strength significantly reduced, so that the electrodes are deemed correctly placed. Thus, the risk of harm or damage to the user 2 is removed.

The physiological characteristic measurement module 20 can measure any suitable physiological characteristic of the user 2, including an electrocardiogram (ECG) signal from the heart or brain wave patterns using electroencephalography (EEG). Thus, using these characteristics, it can be detected whether the electrode(s) 10 have been attached to the user 2 in a way that could affect the heart or brain.

In one embodiment of the invention, the physiological characteristic measurement module 20 is adapted to use the electrodes 10 to measure an electrocardiogram signal from the user 2. In particular, the module 20 attempts to detect an ECG signal (which is straight forward since ECG signals have completely characteristic forms), and if so, it measures the intensity of the detected signal.

If no ECG signal is detected, or if the detected signal has an intensity below a predetermined threshold (as determined by the processor 18), the processor 18 enables the electro-stimulation module 16, so that when a suitable output is received from the computer game console 4, an electro-stimulation signal is provided to the user 2 via the electrodes 10.

If an ECG signal is detected and its intensity is above the predetermined threshold (as determined by the processor 18), the processor 18 disables the electro-stimulation module 16 so that no electro-stimulation signals are generated in response to an appropriate output from the computer game console 4, or attenuates the strength of the electro-stimulation signals generated by the module 16 in response to the output from the computer game console 4. In this situation, the predetermined threshold indicates whether the electrodes have been placed too close to or across the heart (which makes the measured ECG signals stronger).

If the predetermined threshold is exceeded, the processor 18 can provide a warning message to the user 2 indicating that the electrodes 10 have not been attached correctly for the given electro-stimulation signal strength. This warning message can be provided either through a display on the apparatus 8, or through a pop-up message on the display associated with the computer games console 4. The warning message can further provide visual advice relating to the proper positioning of the electrodes 10. If the user 2 is permitted to continue with electro-stimulation after receiving the warning, the strength (i.e. current, voltage, energy and/or power) of the electro-stimulation signals will be significantly reduced to avoid damage to the user 2.

In one embodiment of the invention, the physiological characteristic measurement module 20 can measure the at least one characteristic just before each application of an electro-stimulation signal (i.e. each time that an appropriate output is received from the computer game), in order to ensure that the electrodes 10 have not been repositioned mid-game.

However, taking a measurement before applying an electro-stimulation signal may introduce a delay into the stimulation relative to the action in the game that generated the need for an electro-stimulation signal (or a delay in the game itself). Therefore, in an alternative embodiment of the invention, the module 20 acts to measure the at least one characteristic at each instant that an electro-stimulation signal is not required. Thus, when an appropriate output is received from the computer game, a recent characteristic measurement is already available, and the processor 18 can rapidly determine whether the electro-stimulation signal can be applied.

However, if there is a period where many electro-stimulation signals are applied close together, it might not be possible to maintain an up-to-date characteristic measurement. In this case, the processor 18 can be programmed to halt the application of the signals after a predetermined interval so that a characteristic measurement can be taken by the module 20.

In a further embodiment, the electrodes 10 can be provided with additional sensing means which can detect if an electrode 10 falls off the user 2, preferably making use of the so-called “zero-power lead off detector” technology described in WO 2006/092766 to the present applicant. In this case, a further characteristic measurement can be carried out only in the event that it is detected that an electrode 10 has fallen off the user 2.

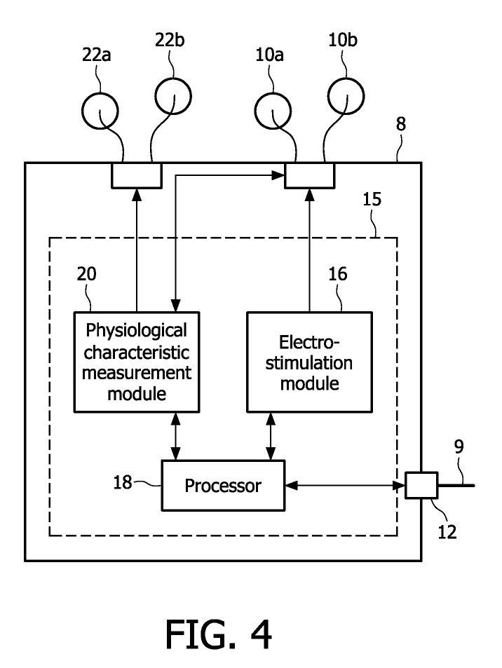

FIG. 4 shows a feedback apparatus in accordance with a second embodiment of the invention. In this Fig., the feedback apparatus 8 corresponds to that shown in FIG. 2, with a set of physiological characteristic measurement sensors 22 (22a, 22b) connected to the physiological characteristic measurement module 20.

In this embodiment, electrodes 10, which are used to apply the electro-stimulation signal to the user 2, are again used to measure at least one physiological characteristic of the user 2. In addition, sensors 22 are used to measure either the same at least one physiological characteristic of the user 2 or a further, preferably related, physiological characteristic, but from a different part of the body, in order to provide a reference measurement for the processor 18.

For example, where the measured physiological characteristic is an ECG signal, the sensors 22a, 22b can be placed on the user 2 in a suitable position for monitoring an ECG signal. The measurements obtained using these sensors 22 are used as a reference signal by the processor 18, and can be used to determine a maximum safe intensity of the signals measured by the electrodes 10a, 10b. Thus, if the strength of the ECG signals measured by the electrodes 10a, 10b are within a particular range of the signal measured by the sensors 22a, 22b (which should be positioned close to the heart), then it can be determined that the electrodes 10a, 10b are too close to the heart, and the electro-stimulation module 16 should be disabled, or the generated electro-stimulation signals attenuated.

Alternatively, or in addition, the sensors 22 and electrodes 10 can measure physiological characteristics whose timing varies based on the position of the electrodes/sensors on the body of the user 2. For example, the electrodes/sensors can measure the user's pulse, or heart rate, as defined by blood pressure variations as blood pumps through the body. In this case, the difference in time between the measurement of a particular pulse near the heart by the sensors 22 and the measurement of that same pulse in a limb by the electrodes 10 can indicate whether the electrodes 10 have been placed a satisfactory distance from the heart.

This type of alternative or additional measurement prevents the circumvention of the safety features by initially or subsequently placing the electrodes on a non-living object.

As described above, any suitable physiological characteristic(s) can be measured by the electrode(s) 10 and/or sensor(s) 22, including ECG signals and EEG signals. Further measurable characteristics include skin conductivity or perspiration, skin temperature, muscle tension, breathing rate or a non-obtrusive measurement of a relevant chemical or biochemical level in the blood or tissue of the user. Furthermore, these measurements can also be used for other purposes by the apparatus 8. For example, a skin conductivity or perspiration measurement can be used to determine an excitement level of the user, which can be fed back into the computer game; a skin temperature measurement, taken using a thermocouple or non-contact infrared sensing thermometer, could be used by the apparatus 8 to detect whether the electrodes 10 have been placed on a non-living object; muscle tension measurements could be used by the apparatus 8 to prevent gaming-related repetitive strain injury (RSI), or to feedback user reaction times into the computer game in order to adapt the game content to a user skill level; and a breathing rate measurement can be used by the apparatus 8 as an alternative measurement for determining a user excitement level.

Thus, in a further embodiment of the invention, the characteristic measurements can be used as an input to the computer game in order to control or adapt the game to the reaction times or current emotional or excitement level of the user (as interpreted from the measurements such as perspiration, heart rate, heart rate variation, breathing rate muscle tension, etc.).

In a further embodiment of the invention, the electrodes 10 and/or sensors 22 can be placed in an item that is suited for attachment to a particular part of the body of the user 2. For example, the electrodes 10 can be placed inside an armband. Thus, the mechanical structure of the armband will prevent a user 2 from placing the electrodes 10 across their chest or head, thus providing fewer placement errors of the electrodes 10 and thereby increasing the overall safety of the feedback device.

In further embodiments of the invention, the feedback apparatus 8 may provide for a user-adjustable electro-stimulation signal strength, which can be set based on a preference of the user 2. Thus, if the processor 18 acts to attenuate the strength of the electro-stimulation signal, it can be reduced from the user-defined level to a lower level.

Although the feedback apparatus 8 has been described and illustrated as a component that is separate to the device that is running the computer game (console 4), it will be appreciated that the feedback apparatus 8 can be integrally formed with the device, or it can be integrally formed with a user interface of the device, such as controller 6.

There is therefore provided a feedback apparatus for a game that provides electro-stimulation and in which the risk of misuse of the device is reduced.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A feedback apparatus for a game, the feedback apparatus comprising:
at least one electrode for attachment to a user of the feedback apparatus; and
a control unit for measuring at least one physiological characteristic of the user via the at least one electrode; for determining whether the at least one electrode has been attached correctly to the user for a predefined electro-stimulation signal level based on the measured at least one physiological characteristic; and for providing an electro-stimulation signal at the predefined level to the user via the at least one electrode in response to an output from the game if it is determined that the at least one electrode has been attached correctly to the user.

2. A feedback apparatus as claimed in claim 1, wherein the control unit is further adapted to prevent the application of an electro-stimulation signal to the user via the at least one electrode if it is determined that the at least one electrode has been attached incorrectly to the user.

3. A feedback apparatus as claimed in claim 1, wherein the control unit is adapted to provide the electro-stimulation signal to the user at a level that is lower than the predefined electro-stimulation level if it is determined that the at least one electrode has not been attached correctly to the user for the predefined signal level.

4. A feedback apparatus as claimed in claim 1 wherein the control unit is adapted to determine whether the at least one electrode has been attached correctly to the user by comparing the measured at least one physiological characteristic to a predetermined threshold value.

5. A feedback apparatus as claimed in claim 1 wherein the control unit is adapted to determine whether the at least one electrode has been attached correctly to the user by comparing the measured at least one physiological characteristic to a predetermined range of values.

6. A feedback apparatus as claimed in claim 1, further comprising at least one physiological characteristic measurement sensor for attachment to the user of the feedback apparatus.

7. A feedback apparatus as claimed in claim 6, wherein the control unit is adapted to measure the at least one physiological characteristic via the sensor and the at least one electrode and to determine whether the at least one electrode has been attached correctly to the user based on a comparison between the measurements of the at least one physiological characteristic by the at least one electrode and the at least one sensor.

8. A feedback apparatus as claimed in claim 1 wherein the control unit is adapted to measure the at least one physiological characteristic when an output from the game is received.

9. A feedback apparatus as claimed in claim 1, wherein the control unit is adapted to measure the at least one physiological characteristic when an output from the game is not received.

10. A feedback apparatus as claimed in claim 1, wherein the control unit is adapted to measure the at least one physiological characteristic at periodic intervals.

11. A feedback apparatus as claimed in claim 1, wherein the at least one electrode is integral with an item for attachment to a particular part of the user.

12. A feedback apparatus as claimed in claim 1, wherein the electro-stimulation signal is a Transcutaneous Electrical Neural Stimulation signal.

13. A feedback apparatus as claimed in claim 1 wherein the at least one physiological characteristic comprises one or more of an electrocardiogram signal, an impedance cardiogram, a ballistocardiogram, an electroencephalography signal, heart rate, heart rate variation, blood pressure, blood pressure variation, skin conductivity, perspiration, skin temperature, muscle tension and breathing rate.

14-15. (canceled)

16. A user interface for a computer or a computer game console, the user interface comprising a feedback apparatus as claimed in claim 1.

17. A method of operating a feedback apparatus for a game, the feedback apparatus having at least one electrode for applying an electro-stimulation signal to a user of the apparatus, the method comprising:
measuring at least one physiological characteristic of the user of the feedback apparatus using the at least one electrode attached to the user;
determining whether the at least one electrode has been attached correctly to the user for a predefined electro-stimulation signal level based on the measured at least one physiological characteristic of the user; and
if it is determined that the at least one electrode has been attached correctly to the user, allowing the application of an electro-stimulation signal at the predefined level to the user via the at least one electrode in response to an output from the game.

18. A method as claimed in claim 17, wherein if it is determined that the at least one electrode has been attached incorrectly to the user, preventing the application of an electro-stimulation signal to the user via the at least one electrode.

19. A method as claimed in claim 17, wherein if it is determined that the at least one electrode has not been attached correctly to the user for the predefined electro-stimulation signal level, providing the electro-stimulation signal to the user at a level that is lower than the predefined electro-stimulation level.

20. A method as claimed in claim 17, wherein the step of determining whether the at least one electrode has been attached correctly to the user comprises comparing the measured at least one physiological characteristic to a predetermined threshold value.

21. A method as claimed in laim 17 wherein the step of determining whether the at least one electrode has been attached correctly to the user comprises comparing the measured at least one physiological characteristic to a predetermined range of values.

22. A method as claimed in claim 17, further comprising the step of measuring the at least one physiological characteristic of the user of the feedback apparatus using at least one sensor attached to the user.

23. A method as claimed in claim 22, wherein the step of determining whether the at least one electrode has been attached correctly to the user comprises comparing the measurements of the at least one physiological characteristic by the at least one electrode and the at least one sensor.

24. A method as claimed in claim 17 wherein the step of measuring the at least one physiological characteristic is performed when an output from the game is received.

25. A method as claimed in claim 17, wherein the step of measuring the at least one physiological characteristic is performed when an output from the game is not received.

26. A method as claimed in claim 17, wherein the step of measuring the at least one physiological characteristic is performed at periodic intervals.

27. A method as claimed inclaim 17 wherein the electro-stimulation signal is a Transcutaneous Electrical Neural Stimulation signal.

28. A method as claimed in claim 17, wherein the at least one physiological characteristic comprises one or more of an electrocardiogram signal, an electroencephalography signal, an impedance cardiogram, a ballistocardiogram, heart rate, heart rate variation, blood pressure, blood pressure variation, skin conductivity, perspiration, skin temperature, muscle tension and breathing rate.

29. A computer readable storage medium comprising code stored thereon for enabling a processor to perform the method according to claim 17.
